(19) United States
(12) Patent Application Publication
(10) Pub. No.: US 2016/0047907 A1
(43) Pub. Date: Feb. 18, 2016

(54) Modular Planar Multi-Sector 90 Degrees FOV Radar Antenna Architecture

(71) Applicant: Google Inc., Mountain View, CA (US)

(72) Inventors: Jamal Izadian, San Jose, CA (US); Russell Smith, Mountain View, CA (US)

(21) Appl. No.: 14/459,389

(22) Filed: Aug. 14, 2014

(51) Int. Cl. G01S 13/02

(52) U.S. Cl. CPC G01S 13/02

(57) ABSTRACT

In one aspect, the present application describes an apparatus for a radar system. The apparatus may include a vehicle with four radar units mounted on it. Each radar unit may be configured with a half-power scanning beamwidth and a respective broadside direction. The half-power scanning beamwidth of each radar unit may be configured to scan approximately 90 degrees. A first radar unit may have a broadside direction that is approximately 90 degrees from respective broadside directions of a second radar unit and a fourth radar unit. The second radar unit may have a broadside direction that is approximately 90 degrees from respective broadside directions of the first radar unit and a third radar unit. The third radar unit has a broadside direction that is approximately 90 degrees from respective broadside directions of the second radar unit and the fourth radar unit.

### BACKGROUND

Unless otherwise indicated herein, the materials described in this section are not prior art to the claims in this application and are not admitted to be prior art by inclusion in this section.

Radio detection and ranging (RADAR) systems can be used to actively estimate distances to environmental features by emitting radio signals and detecting returning reflected signals. Distances to radio-reflective features can be determined according to the time delay between transmission and reception. The radar system can emit a signal that varies in frequency over time, such as a signal with a time-varying frequency ramp, and then relate the difference in frequency between the emitted signal and the reflected signal to a range estimate. Some systems may also estimate relative motion of reflective objects based on Doppler frequency shifts in the received reflected signals.

Directional antennas can be used for the transmission and/or reception of signals to associate each range estimate with a bearing. More generally, directional antennas can also be used to focus radiated energy on a given field of view of interest. Combining the measured distances and the directional information allows for the surrounding environment features to be mapped. The radar sensor can thus be used, for instance, by an autonomous vehicle control system to avoid obstacles indicated by the sensor information.

Some example automotive radar systems may be configured to operate at an electromagnetic wave frequency of 77 Giga-Hertz (GHz), which corresponds to a millimeter (mm) wave electromagnetic wave length (e.g., 3.9 mm for 77 GHz). These radar systems may use antennas that can focus the radiated energy into tight beams in order to enable the radar system to measure an environment with high accuracy, such as an environment around an autonomous vehicle. Such antennas may be compact (typically with rectangular form factors), efficient (i.e., with little of the 77 GHz energy lost to heat in the antenna or reflected back into the transmitter electronics), and low cost and easy to manufacture (i.e., radar systems with these antennas can be made in high volume).

### SUMMARY

Disclosed herein are embodiments that relate to a Modular Planar Multi-Sector 90 Degrees Field of View Radar Antenna Architecture. In one aspect, the present application describes an apparatus for a radar system. The apparatus may include a vehicle with four radar units mounted on it. Each of the four radar units may be configured with a half-power scanning beamwidth and a respective broadside direction. The half-power scanning beamwidth of each radar unit may be configured to scan approximately 90 degrees. A first radar unit of the four radar units may have a respective broadside direction that is approximately 90 degrees from respective broadside directions of a second radar unit and a fourth radar unit of the four radar units. The second radar unit of the four radar units may have a respective broadside direction that is approximately 90 degrees from respective broadside directions of the first radar unit and a third radar unit of the four radar units. The third radar unit of the four radar units has a respective broadside direction that is approximately 90 degrees from respective broadside directions of the second radar unit and the fourth radar unit of the four radar units. And, the fourth radar unit of the four radar units has a respective broadside direction that is approximately 90 degrees from respective broadside directions of the first radar unit and the third radar unit of the four radar units.

In another aspect, the present application describes a method. The method may involve operating a vehicle mounted radar system. The method may further involve determining a target direction for the radar operation. The method may still further involve determining a sector associated with the target direction from among a plurality of sectors. The method may yet still further involve enabling a radar unit associated with the determined sector. And, the method may also include directing a radar beam in a beam direction nearest to the target direction.

In yet another example, a computing device is provided. The computing device may include a processor and a computer readable medium having stored thereon program instructions that when executed by the processor cause the computing device to perform functions. The functions include determining a target direction for the radar operation. The functions may still further involve determining a sector associated with the target direction from among a plurality of sectors. The functions may yet still further involve enabling a radar unit associated with the determined sector. And, the functions may also include directing a radar beam in a beam direction nearest to the target direction.

In another aspect, the present application describes an apparatus. The apparatus may include operating a vehicle mounted radar system. The apparatus may further include means for determining a target direction for the radar operation. The apparatus may still further include means for determining a sector associated with the target direction from among a plurality of sectors. The apparatus may yet still further involve means for enabling a radar unit associated with the determined sector. And, the apparatus may also include means for directing a radar beam in a beam direction nearest to the target direction.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates an example of radiating slots on a waveguide.

FIG. 2 illustrates an example waveguide with ten radiating Z-Slots.

FIG. 3 illustrates an example radar system with six radiating waveguides.

FIG. 4 illustrates an example radar system with six radiating waveguides and a waveguide feed system.

FIG. 5 illustrates example beam steering for a sector for a radar unit.

FIG. 6 illustrates an example layout of radar sectors.

FIG. 7 is an example method for operating a vehicle mounted radar system.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The following detailed description relates to an apparatus for a modular planar multi-sector 90 degree field of view radar antenna architecture. In practice, vehicular radar systems may feature radar systems with various field of views and different configurations. Typically, radar systems in vehicles are primarily focused in a forward direction. For example, a vehicle may include a radar system designed to measure a following distance from the vehicle to another vehicle it is following. Thus, a forward-looking radar may be used. However, a forward-looking radar may not be able to control a direction of the radar beam, thus it may only be able to interrogate one portion of the area around a vehicle.

More advanced radar systems may be used with a vehicle in order to obtain a wider field of view than just that directly in front of the vehicle. For example, it may be desirable either for a radar to be able to steer a radar beam or for a vehicle to feature multiple radar units pointing in different directions. Thus, the radar system may be able to interrogate different regions than just the region in front of the car. In some examples, multiple radar units may be combined with steerable radar beams to further increase the interrogation region of the vehicular radar system.

Disclosed here is a planar multi-sector 90 degree field of view radar antenna architecture that may enable an antenna to both scan across approximately 90-degrees of the azimuth plane (e.g. the horizontal plane) while also being mountable on various surfaces of a vehicle. Having a radar antenna with a 90 degree field of view may enable a radar system to scan a full 360 azimuth plane by having four radar units each configured to scan one 90-degree non-overlapping sector. Therefore, the presently disclosed radar system may be able to steer a radar beam to interrogate the entire region in the azimuth plane of the vehicle. So that for example, four such radars located on four corners of a car would provide a full 360 coverage around the car. For example, a system such as this may aid in autonomous driving of a vehicle.

When each radar unit can scan or span a 90-degree region, placing 4 radar units on a vehicle may enable the vehicle to scan a beam over the full 360 azimuth plane. Each of the four radar units may be configured to scan a beam over one sector (i.e. one quarter of the azimuth plane) and thus the entire plane may be scanned by the combination of the four radar units. In various examples, the placement of the radar units may be adjusted depending on the specific vehicle, the requirements of the radar system, or other design criteria. In some additional examples, the radar units may be configured to scan a region of an angular width that is not 90 degrees. For example, some radar units may scan 30 degrees, 120 degrees, or another angle. Further, in some examples, the radar units on the vehicle may scan less than the full 360 azimuth plane.

In some examples, the radar sectors may be defined based on where the radar units may be mounted on the vehicle. In one example, one radar unit may be mounted in each of the side mirrors of the vehicle. The other two radar units may be mounted behind the taillights of the vehicle. In this example, the quadrants may be defined based on axes where one axis aligns with the direction of vehicular motion and the other axis aligns with the middle of the vehicle from front to back. In another example, the radar units may be mounted in order to have one pointing forward, one pointing backward, and one pointing to each side. In this second example, the axes of the quadrants may be at a 45 degree angle to the direction of motion of the vehicle. Additionally, the radar unit may be mounted on top of the vehicle.

The modular planar multi-sector 90 degree field of view radar antenna architecture may be able to steer the radar beams emitted from each radar unit. The radar beams may be steered by the radar units in various ways. For example, in some embodiments, the radar units may be able to steer the beam in an approximately continuous manner across the 90 degree field of view for the respective antenna or the radar units may be configured with sectoral sub beams spanning the 90 degrees. In other embodiments, the radar units may be able to steer the radar beam to predetermined directions within the 90 degree field of view for the respective antenna. For example, one radar unit may be able to steer a radar beam to four discrete angles within the 90 degree field of view for the respective antenna. In this example, the four angles may be approximately −36, −12, 12, and 36 degrees (as measured from the broadside, or normal to, the radiating surface of the radar unit.

Additionally, each radar unit may have a half-power beamwidth of approximately 22.5 degrees. The half-power beamwidth describes the width, measured in degrees, of a main lobe of the radar beam between two points that correspond to half the amplitude of the maximum of the radar beam. In various embodiments, the half-power beamwidth of the radar beam may be different than 22.5 degrees. Additionally, in some embodiments, the half-power beamwidth of the radar beam may change depending on the angle at which the radar beam is pointed. For example, the half-power beamwidth of the radar beam may be narrower when the radar beam is pointed orthogonal (i.e. broadside) to the radiating surface and widen and the radar beam is steered away from the orthogonal direction. By steering the beam to each of these four angles, the radar unit may be able to scan or span the full 90 degree field of view.

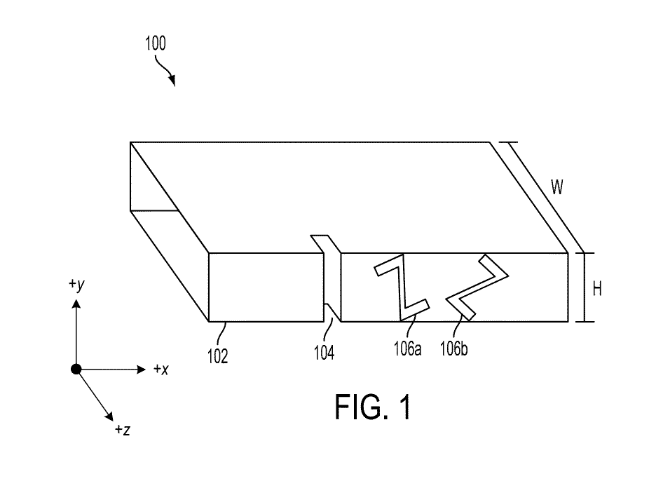

Referring now to the figures, FIG. 1 illustrates an example of radiating slots (104, 106a, 106b) on a waveguide 102 in radar unit 100. It should be understood that radar unit 100 presents one possible configuration of radiating slots (104, 106a, 106b) on a waveguide 102.

It should also be understood that a given application of such an antenna may determine appropriate dimensions and sizes for both the radiating slots (104, 106a, 106b) and the waveguide 102. For instance, as discussed above, some example radar systems may be configured to operate at an electromagnetic wave frequency of 77 GHz, which corresponds to a 3.9 millimeter electromagnetic wave length. At this frequency, the channels, ports, etc. of an apparatus fabricated by way of method 100 may be of given dimensions appropriated for the 77 GHz frequency. Other example antennas and antenna applications are possible as well.

Waveguide 102 of radar unit 100 has a height of H and a width of W. As shown in FIG. 1, the height of the waveguide extends in the Y direction and the width extends in the Z direction. Both the height and width of the waveguide may be chosen based on a frequency of operation for the waveguide 102. For example, when operating waveguide 102 at 77 GHz, the waveguide 102 may be constructed with a height H and width W to allow propagation of 77 GHz wave. An electromagnetic wave may propagate through the waveguide in the X direction. In some examples, the waveguide may have a standard size such as a WR-12 or WR-10. A WR-12 waveguide may support the propagation of electromagnetic waves between 60 GHz (5 mm wavelength) and 90 GHz (3.33 mm wavelength). Additionally, a WR-12 waveguide may have the internal dimensions of approximately 3.1 mm by 1.55 mm. A WR-10 waveguide may support the propagation of electromagnetic waves between 75 GHz (4 mm wavelength) and 110 GHz (2.727 mm wavelength). Additionally, a WR-12 waveguide may have the internal dimensions of approximately 2.54 mm by 1.27 mm. The dimensions of the WR-12 and the WR-10 waveguides are presented for examples. Other dimension are possible as well.

Waveguide 102 may be further configured to radiate the electromagnetic energy that is propagating through the waveguide. The radiating slots (104, 106a, 106b), as shown in FIG. 1, may be located on the surface of the waveguide 102. Additionally, as shown in FIG. 1, the radiating slots (104, 106a, 106b) may be located primarily on the side of the waveguide 102 with the height H dimension. Further, the radiating slots (104, 106a, 106b) may be configured to radiate electromagnetic energy in the Z direction.

The linear slot 104 may be a traditional waveguide radiating slot. A linear slot 104 may have a polarization in the same direction as the long dimension of the slot. The long dimension of the linear slot 104, measured in the Y direction, may be approximately one-half of the wavelength of the electromagnetic energy that is propagating through the waveguide. At 77 Ghz, the long dimension of the linear slot 104 may be approximately 1.95 mm to make the linear slot resonant. As shown in FIG. 1, the linear slot 104 may have a long dimension that is larger than the height H of the waveguide 102. Thus, the linear slot 104 may be too long to fit on just the side of the waveguide having the height H dimension. The linear slot 104 may continue on to the top and bottom of the waveguide 102. Additionally, a rotation of the linear slot 104 may be adjusted with respect to the orientation of the waveguide. By rotating the linear slot 104, an impedance of the linear slot 104 and a polarization and intensity of the radiation may be adjusted.

Additionally, the linear slot 104 has a width dimension that may be measured in the X direction. Generally, the width of the waveguide may be varied to adjust the bandwidth of the linear slot 104. In many embodiments, the width of the linear slot 104 may be approximately 10% of the wavelength of the electromagnetic energy that is propagating through the waveguide. At 77 Ghz, the width of the linear slot 104 may be approximately 0.39 mm. However, the width of the linear slot 104 may be made wider or narrower in various embodiments.

However, in some situations, it may not be practical or possible for a waveguide 102 to have a slot on any side other than the side of the waveguide having the height H dimension. For example, some manufacturing processes may create a waveguide structure in layers. The layers may cause only one side of the waveguide to be exposed to free space. When the layers are created, the top and bottom of the respective waveguide may not be exposed to free space. Thus, a radiating slot that extends to the top and bottom of the waveguide would not be fully exposed to free space, and therefore would not function correctly, in some configurations of the waveguide. Therefore, in some embodiments, folded slots 106a and 106b may be used to radiate electromagnetic energy from the inside the waveguide.

A waveguide may include slots of varied dimensions, such as folded slots 106a and 106b, in order to radiate electromagnetic energy. For example, folded slots 106a and 106b may be used on a waveguide in situations when a half-wavelength sized slot cannot fit on the side of the waveguide. The folded slots 106a and 106b each may have an associated length and width. The total length of the folded slots 106a and 106b, as measured through a curve or a bend in the folded slot, may be approximately equal to half the wavelength of the electromagnetic energy in the wave. Thus, at the same operating frequency, the folded slots 106a and 106b may have approximately the same overall length as the linear slot 104. As shown in FIG. 1, folded slots 106a and 106b are Z-Slots, as each is shaped like the letter Z. In various embodiments, other shapes may be used as well. For example, both S-Slots and 7-Slots may be used as well (where the slot is shaped like the letter or number it is named after).

The folded slots 106a and 106b may also each have a rotation. Similarly as described above, a rotation of the folded slots 106a and 106b may be adjusted with respect to the orientation of the waveguide. By rotating the folded slots 106a and 106b, an impedance of the folded slots 106a and 106b and a polarization of the radiation may be adjusted. The radiation intensity may also be varied by such a rotation, which can be used for amplitude tapers for arraying to lower Side Lobe Level (SLL). The SLL will be discussed further with respect to the array structure.

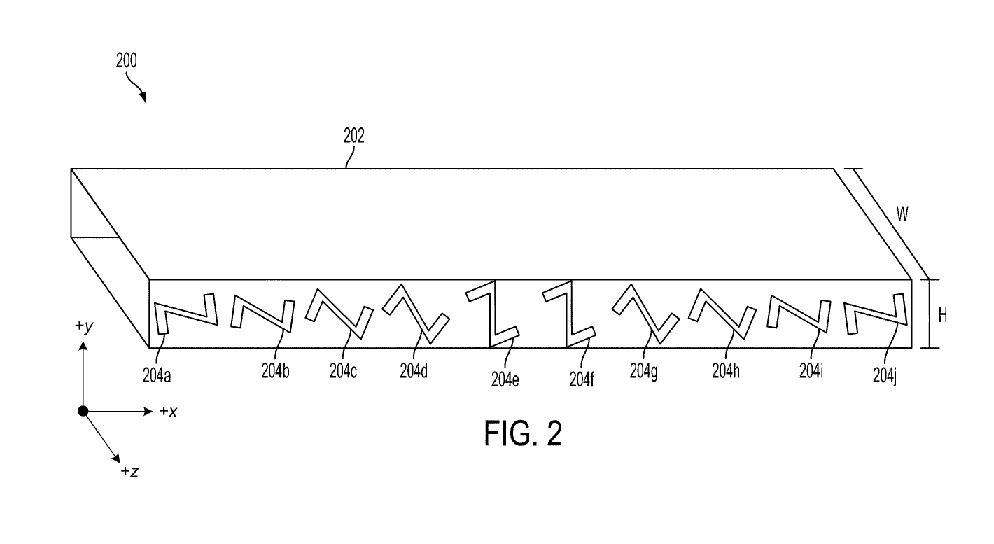

FIG. 2 illustrates an example waveguide 202 with 10 radiating Z-Slots (204a-204j) in radar unit 200. As electromagnetic energy propagates down a waveguide 202, a portion of the electromagnetic energy may couple into one or more of the radiating Z-Slots (204a-204j) on the waveguide 202. Thus, each of the radiating Z-Slots (204a-204j) on the waveguide 202 may be configured to radiate an electromagnetic signal (in the Z direction). In some instances, each of the radiating Z-Slots (204a-204j) may have an associated impedance. The impedance for each respective radiating Z-Slot (204a-204j) may be a function of both the dimensions of the respective slot and the rotation of the respective slot. The impedance of each respective slot may determine a coupling coefficient for each respective radiating Z-Slot. The coupling coefficient determines a percentage of the electromagnetic energy propagating down a waveguide 202 that is radiated by the respective Z-Slot.

In some embodiments, the radiating Z-Slots (204a-204j) may be configured with rotations based on a taper profile. The taper profile may specify a given coupling coefficient for each radiating Z-Slots (204a-204j). Additionally, the taper profile may be chosen to radiate a beam with a desired beamwidth. For example, in one embodiment shown in FIG. 2, in order to obtain the taper profile, the radiating Z-Slots (204a-204j) may each have an associated rotation. The rotation of each radiating Z-Slot (204a-204j) may cause the impedance of each slot to be different, and thus cause the coupling coefficient for each radiating Z-Slot (204a-204j) to correspond to the taper profile. The taper profile of the radiating Z-Slots 204a-204j of the waveguide 202, as well as taper profiles of other radiating Z-Slots of other waveguides may control a beamwidth of an antenna array that includes a group of such waveguides. The taper profile may also be used to control SLL of the radiation. When an array radiates electromagnetic energy, the energy is generally radiated into a main beam and side lobes. Typically, sidelobes are an undesirable side effect from an array. Thus, the taper profile may be chosen to minimize or reduce the SLL (i.e. the amount of energy radiated in sidelobes) from the array.

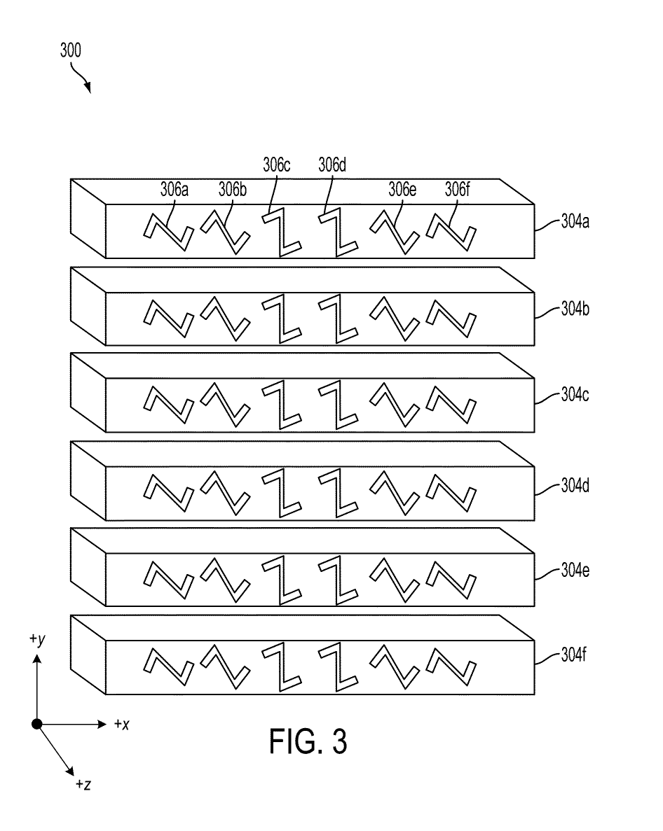

FIG. 3 illustrates an example radar system 300 with six radiating waveguides 304a-304f. Each of the six radiating waveguides 304a-304f may have radiating Z-Slots 306a-306f. Each of the six radiating waveguides 304a-304f may be similar to the waveguide 202 described with respect to FIG. 2. In some embodiments, a group of waveguides, each containing radiating slots, may be known as an antenna array. The configuration of the six radiating waveguides 304a-304f of the antenna array may be based on both a desired radiation pattern and a manufacturing process for the radar system 300. Two of the components of the radiation pattern of the radar system 300 include a beam width as well as a beam angle. For example, similar to as discussed with FIG. 2, a taper profile of the radiating Z-Slots 306a-306f of each of the radiating waveguides 304a-304f may control a beamwidth of the antenna array. A beamwidth of the radar system 300 may correspond to an angle with respect to the antenna plane (e.g. the X-Y plane) over which a majority of the radar system's radiated energy is directed.

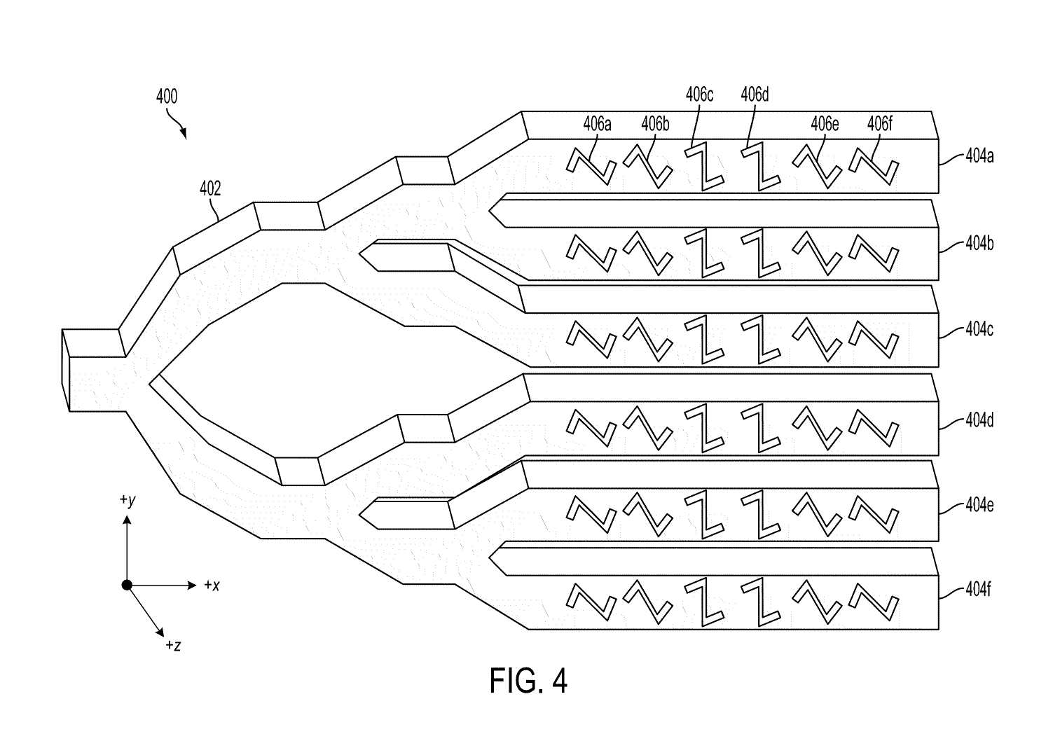

FIG. 4 illustrates an example radar system 400 with six radiating waveguides 404a-404f and a waveguide feed system 402. The six radiating waveguides 404a-404f may be similar to the six radiating waveguides 304a-304f of FIG. 3. In some embodiments, the waveguide feed system 402 may be configured to receive an electromagnetic signal at an input port and divide the electromagnetic signal between the six radiating waveguides 404a-404f. Thus, the signal that each radiating Z-Slot 406a-406f of each of the radiating waveguides 404a-404f radiates may propagate in the X direction through the waveguide feed system. In various embodiments, the waveguide feed system 402 may have different shapes or configurations than that shown in FIG. 4. Based on the shape and configuration of the waveguide feed system 402 various parameters of the radiated signal may be adjusted. For example, a direction and a beamwidth of a radiated beam may be adjusted based on the shape and configuration of the waveguide feed system 402.

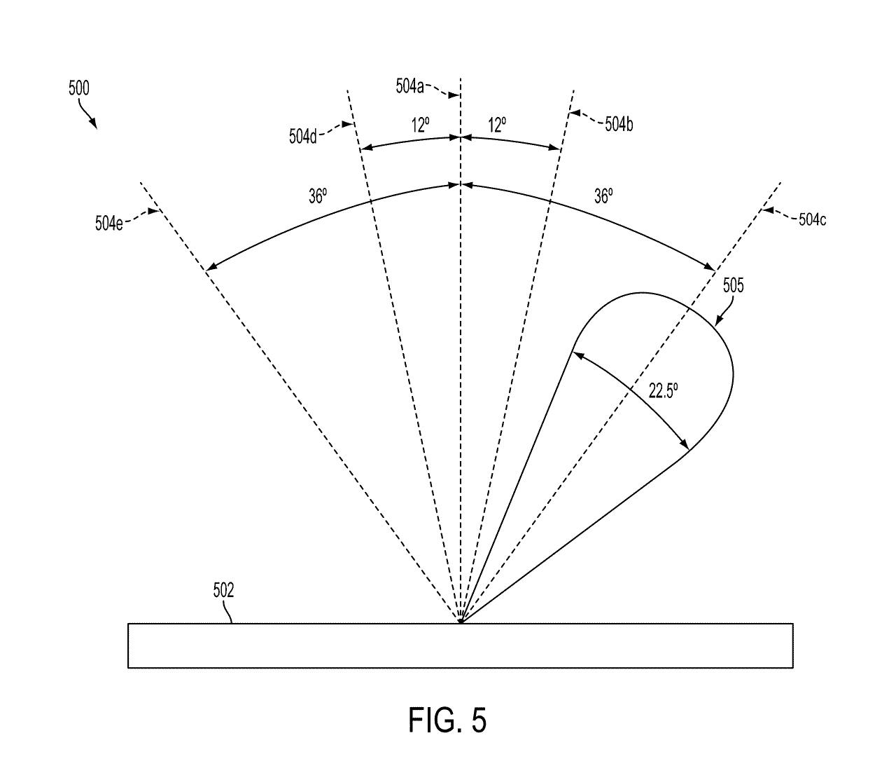

FIG. 5 illustrates example beam steering for a sector for a radar unit 500. The radar unit 500 may be configured with a steerable beam, i.e., the radar unit 500 may be able to control a direction in which the beam is radiated. By controlling the direction in which the beam is radiated, the radar unit 500 may be able to direct radiation in a specific direction in order to determine radar reflections (and thus objects) in that direction. In some embodiments, the radar unit 500 may be able to scan a radar beam in a continuous manner across the various angles of the azimuth plane. In other embodiments, the radar unit 500 may be able to scan the radar beam in discrete steps across the various angles of the azimuth plane.

The example radar unit 500 in FIG. 5 has a radar beam 506 that can be steered across a plurality of different angles. As shown in FIG. 5, the radar beam 506 may have a half-power beamwidth of approximately 22.5 degrees. The half-power beamwidth describes the width, measured in degrees, of a main lobe of the radar beam 506 between two points that correspond to half the amplitude of the maximum of the radar beam 506. In various embodiments, the half-power beamwidth of the radar beam 506 may be different than 22.5 degrees. Additionally, in some embodiments, the half-power beamwidth of the radar beam 506 may change depending on the angle at which the radar beam 506 is pointed. For example, the half-power beamwidth of the radar beam 506 may be narrower when the radar beam 506 is pointed more closely to the orthogonal 504a (i.e. broadside) direction to the radiating surface and widen and the radar beam 506 is steered away from the orthogonal direction 504a.

In the example shown in FIG. 5, the radar beam may be able to be steered to four different angles. The steering angle may be measured with respect to the orthogonal 504a (i.e. broadside) direction to the radiating surface. The beam may be steered to +36 degrees at 504c and −36 degrees at 504e. Also, the beam may be steered to +12 degrees at 504b and −12 degrees at 504d. The four different angles may represent the discrete angles to which the radar beam 506 may be steered. In some additional examples, the radar beam may be able to be steered to two angles simultaneously. For example, the radar beam may be steered to both +12 and −12 degrees at the same time. This may result in a beam that is overall steered in the direction of the sum of the angles (e.g. −12+12=0, thus the beam in this example would be in the broadside direction 504a). However, when a radar beam is steered at two directions at once, the half-power beamwidth of the radar beam may be widened. Thus, a radar resolution may decrease.

By steering the radar beam 506 to each of angles 504b-504e, the full 90 degree field of view can be scanned. For example, when the radar beam 506 is steered to +36 degrees 504c, the half-power beamwidth of the radar beam 506 will cover from +47.25 degrees to +24.75 degrees (as measured from the broadside direction 504a). Additionally, when the radar beam 506 is steered to −36 degrees 604e, the half-power beamwidth of the radar beam 506 will cover from −47.25 degrees to −24.75 degrees. Further, when the radar beam 506 is steered to +12 degrees 504b, the half-power beamwidth of the radar beam 506 will cover from +23.25 degrees to +0.75 degrees. And finally, when the radar beam 506 is steered to −12 degrees 504d, the half-power beamwidth of the radar beam 506 will cover from −23.25 degrees to −0.75 degrees. Thus, the radar beam 506 will effectively be able to scan (i.e. selectively enable or disable the four beams spanning the angular width) from −47.25 to +47.25 degrees, covering a range of 95 degrees. The number of steering angles, the direction of the steering angles, and the half-power beamwidth of the radar beam 506 may be varied depending on the specific example.

For example, and further discussed below, a radar beam of a radar unit may be configured to only scan a 60 degree region. If a radar unit can scan a 60 degree region, six radar units may be used to scan a full 360 azimuth plane. However, if the radar unit can scan 90 degrees, four radar units may scan the full 360 azimuth plane.

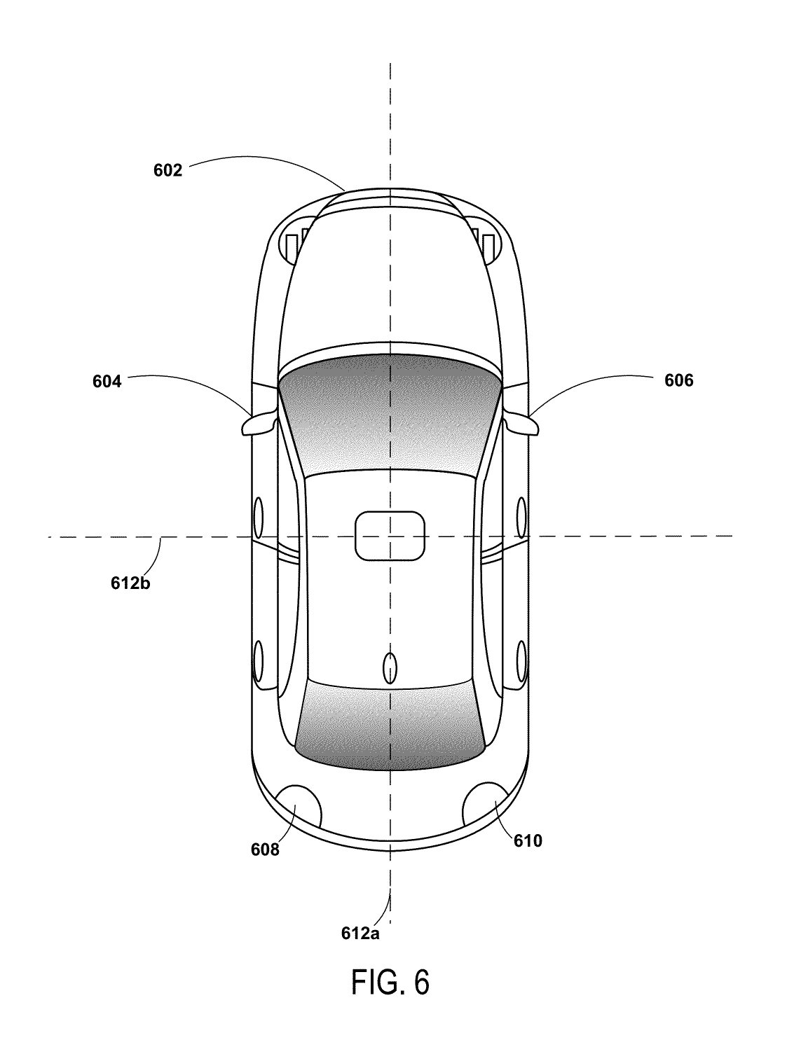

FIG. 6 illustrates an example layout of radar sectors for an autonomous vehicle 602. As shown in FIG. 6, each of the radar sectors may have an angular width approximately equal to the scanning range of the radar units as described with respect to FIG. 5. For example, the sectors of FIG. 6 divide the azimuth plane around the autonomous vehicle 602 into 90 degree sectors. However, in examples where the radar units are configured to scan a radar beam over a different angle than 90 degrees, the width and number of sectors may change.

As shown in FIG. 6, the radar sectors may align with the axes (612a and 612b) of the vehicle 602. For example, there may be a front left, front right, rear left, and rear right sector defined by the midpoints of the vehicle 602. Because each sector corresponds to one radar unit, each radar unit may be configured to scan across one sector. Further, because each example radar unit of FIG. 6 has an scanning angle of approximately 90 degrees, each radar unit scans a region that approximately does not overlap with the scanning angle of any other radar unit.

In order to achieve radar sectors defined by the midpoints of the vehicle 602, each radar unit may be mounted at a 45 degree angle with respect to the two axes of the vehicle 602. By mounting the radar units a 45 degree angle with respect to the two axes of the vehicle 602, a 90 degree scan of the radar unit would scan from one vehicle axis to the other vehicle axis. For example, a radar unit mounted at a 45 degree angle to the axes in side mirror unit 604 may be able to scan the front left sector (i.e. from the vertical axis 612a through the front of the vehicle 602 to the axis 612b that runs through the side of the vehicle). An additional radar unit may be mounted at a 45 degree angle to the axes in side mirror unit 606 may be able to scan the front right sector. In order to scan the back right sector, a radar unit may be mounted in taillight unit 610. Additionally, in order to scan the back left sector, a radar unit may be mounted in taillight unit 608. The radar unit placements shown in FIG. 6 are merely one example. In various other examples, the radar units may be placed in other locations, such as on top of the vehicle, or within or behind other vehicle components. Further, the sectors may also be defined differently in various embodiments. For example, the sectors may be at a 45 degree angle with respect to the vehicle. In this example, one radar unit may face forward, another backward, and the other two to the sides of the vehicle.

In some examples, all the radar units of vehicle 602 may be configured with the same scanning angle. The azimuth plane around the vehicle is equal to a full 360 degrees. Thus, if each radar unit is configured with the same scanning angle, then the scanning angle for the radar units would be equal to approximately 360 divided by the number of radar units on the vehicle. Thus, for full azimuth plane scanning, a vehicle 602 with one radar unit would need that radar unit to be able to scan over the full 360 degrees.

If the vehicle 602 had two radar units, each would scan approximately 180 degrees. For three radar units, each would be configured to scan 120 degrees. For four radar units, as shown in FIG. 6, each may scan approximated 90 degrees. Five radar units may be configured on the vehicle 602 and each may be able to scan 72 degrees. Further, six radar units may be configured on the vehicle 602 and each may be able to scan approximately 60 degrees.

The number of radar units may be chosen based on a number of criteria, such as ease of manufacture of the radar units, vehicle placement, or other criteria. For example, some radar units may be configured with a planar structure that is sufficiently small. The planar radar unit may be mountable at various positions on a vehicle. For example, a vehicle may have a dedicated radar housing mounted on the top of the vehicle. The radar housing may contain various radar units. However, in other embodiments, radar units may be placed within the vehicle structure.

When radar units are located within the vehicle structure, each may not be visible from outside the vehicle without removing parts of the vehicle. Thus, the vehicle may not be altered aesthetically, cosmetically, or aerodynamically from adding radar units. For example, radar units may be placed under vehicle trim work, under bumpers, under grills, within housings for lights, within side mirrors, or other locations as well. In some embodiments, it may be desirable to place radar units in positions where the object covering the radar unit is at least partially transparent to radar. For example, various plastics, polymers, and other materials may form part of the vehicle structure and cover the radar units, while allowing the radar signal to pass through.

Additionally, in some embodiments, the radar units may be configured with different scanning ranges for different radar units. For example, in some embodiments a specific radar unit with a wide scanning angle may not be able to be placed on the vehicle in the proper location. Thus, a smaller radar unit, with a smaller scanning angle may be placed in that location. However, other radar units may be able to have larger scanning angles. Therefore, the total scanning angle of the radar units may add up to 360 degrees (or more) and provide full 360 degree azimuthal scanning. For example, a vehicle may have 3 radar units that each scan over 100 degrees and a fourth radar unit that scans over 60 degrees. Thus, the radar units may be able to scan the full azimuth plane, but the scanning sectors may not be equal in angular size.

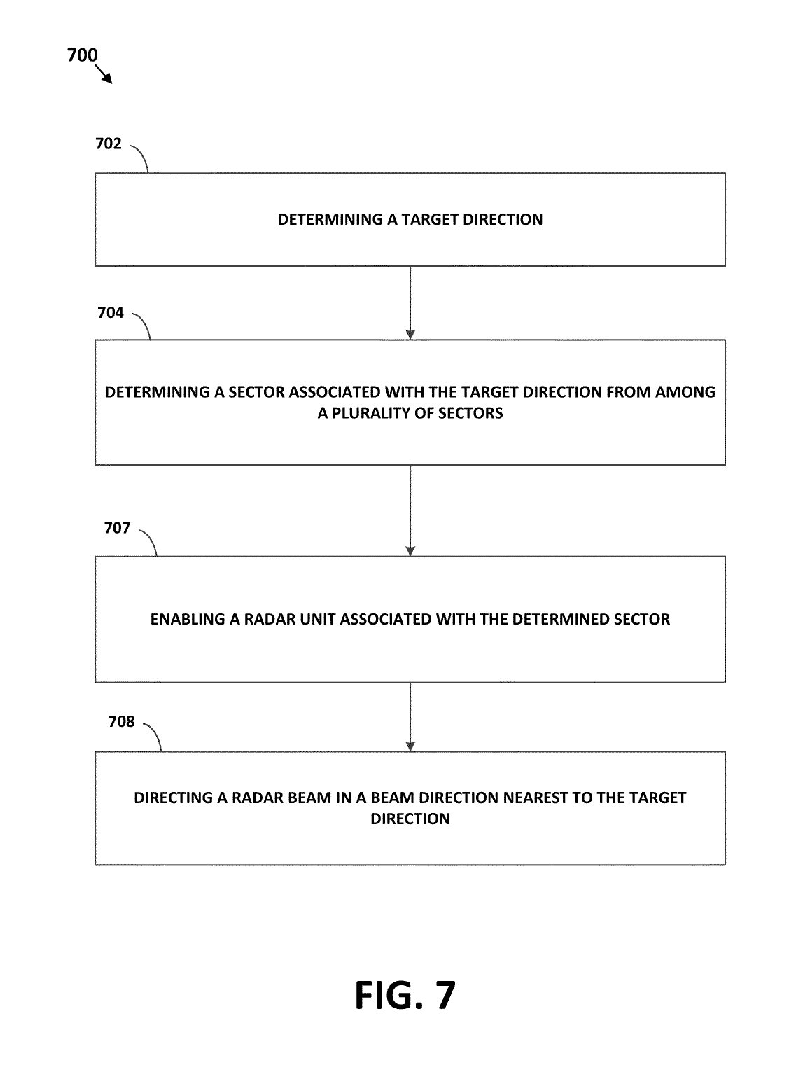

FIG. 7 is an example method for for operating a vehicle mounted radar system. Moreover, the method 700 of FIG. 7 will be described in conjunction with FIGS. 1-6. A vehicular radar system may be configured to interrogate the region around the vehicle. To interrogate the region around the vehicle, the radar system may transmit the radar beam in a given direction. The transmitted beam may reflect off objects in the region, and these reflections may be received by the radar unit. The received reflections may allow the radar system and a computer to determine what objects are located near the vehicle. Not only may objects themselves be determined, but the location (i.e. angle and range to objects) may be determined as well.

At block 702, the method 700 includes determining a target direction. The target direction may be determined in a number of different ways. For example, a radar system may be configured to continuously scan a radar beam in a circle across the azimuth plane around the vehicle. By continuously scan a radar beam in a circle, the radar system may continuously and periodically interrogate all directions around the vehicle.

In other examples, the radar system may be configured to periodically scan the radar beam in various directions depending on the operation mode of the vehicle. For example, while a vehicle is driving, the radar system may be configured to primarily scan the radar beam in the direction of travel of the vehicle. The radar beam may be focused in the direction of travel in order to improve detection of objects that may be located in front of the vehicle. However, although the radar system may primarily scan the radar beam in the direction of travel of the vehicle, it may also scan in other directions, albeit less frequently, to obtain information about objects in directions other than the direction in which the vehicle is traveling.

In additional examples, the radar system may use other various algorithms to determine a target direction. Some algorithms may use a feedback mechanism from the radar system to determine target direction. For example, a radar system may be configured to transmit a beam in a predefined pattern. However, based on either objects reflecting radar (or a lack of reflecting objects) the radar system may change the pattern and/or direction in which the radar unit is transmitting the radar signal.

The specific mechanism of how the radar system selects a target direction is not necessary for this specific application. The present disclosure functions similarly regardless of how a target direction is chosen.

At block 704, the method 700 includes determining a sector associated with the target direction from among a plurality of sectors. Each direction of possible radar transmission may correspond to one of the radar sectors of the vehicle. Thus, when a target direction is determined, an associated sector may be calculated based on the target direction. For example, a radar system may contain a database that relates target directions to specific radar sectors. In other examples, the radar system may have a processor that can calculate a radar sector based on the target direction.

At block 706, the method 700 includes enabling a radar unit associated with the determined sector. When a sector is determined, the radar unit associated with that sector may be enabled. Thus, once enabled that radar unit may be able to transmit a radar signal. In some examples, the various radar units may not be powered until a specific radar unit used for radar transmission. Therefore, an unpowered radar unit may be enabled by powering up the radar unit to enable it to transmit a radar signal

In some further examples, enabling a radar unit may include switching on a radar transmitter associated with the respective radar unit. In other examples, the radar units may be in non-transmitting standby mode when the respective radar unit is not transmitting radar. In this example, enabling the radar unit may include activating the radar transmission mode of the radar unit. In various examples, radar units may operate in either an active transmission mode or a passive mode. Passive mode may mean a radar unit is either waiting to be enabled for transmission, passively receiving radar, or both. Block 706 causes a radar unit to prepare to transmit a radar signal.

At block 708, the method 700 includes directing a radar beam in a beam direction nearest to the target direction. In some examples the determined target direction may not directly correspond with a steering angle of the radar unit. Thus, the radar unit may be configured to transmit a radar signal with a radar steering angle of the possible radar steering angles of the radar unit closest to the target angle.

For example, a target angle may be 17 degrees as measured from the forward facing direction of the vehicle. If the radar unit described with respect to FIG. 5 is used in a 45 degree mounting angle (as discussed with respect to FIG. 6), it may not be possible for the radar unit to transmit a radar signal at exactly 17 degrees. However, if a radar unit like radar unit 502 of FIG. 5 is mounted so the radar unit 502 broad side angle 504a is pointed at 45 degrees, it can steer a beam in the −36 degree relative to broadside direction 504e. This would cause a radar beam to pointed at 9 degrees (45 degree broadside beam steered at −36 degrees, 45−36=9). Thus, the target direction of 17 degrees would be within the half power beamwidth of this radar transmission. When a beam is steered at 9 degrees relative to the forward direction of the vehicle, the half-power beamwidth of the radar signal may cover from −2.25 degrees through 20.25 degrees. Therefore, when a target direction of 17 degrees is desired, the beam is steered in a direction closest to 17 degrees in which a radar unit can transmit a radar signal.

By repeating block 708, the radar unit may be able to steer a radar beam in various directions in order to interrogate the full azimuth plane around the vehicle. Thus, the radar beam may not be continuously scanned to every individual angle in the azimuth plane, but by scanning at each discrete angle the full azimuth plane may be interrogated. Therefore, a vehicular radar system may be able to detect objects in the full 360 region around the vehicle through using multiple radar units and dividing the azimuth plane into sectors.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the scope being indicated by the following claims.

What is claimed is:

1. A radar system comprising:
a vehicle; and
four radar units mounted to the vehicle, wherein:
each of the four radar units is configured with a half-power scanning beamwidth and a respective broadside direction, wherein the half-power scanning beamwidth of each radar unit is configured to scan approximately 90 degrees,
a first radar unit of the four radar units has a respective broadside direction that is approximately 90 degrees from respective broadside directions of a second radar unit and a fourth radar unit of the four radar units,
the second radar unit of the four radar units has a respective broadside direction that is approximately 90 degrees from respective broadside directions of the first radar unit and a third radar unit of the four radar units,
the third radar unit of the four radar units has a respective broadside direction that is approximately 90 degrees from respective broadside directions of the second radar unit and the fourth radar unit of the four radar units, and
the fourth radar unit of the four radar units has a respective broadside direction that is approximately 90 degrees from respective broadside directions of the first radar unit and the third radar unit of the four radar units.

2. The radar system according to claim 1, wherein the first radar unit is mounted on a left side view mirror unit of the vehicle and the second radar unit is mounted on a right side view mirror unit of the vehicle.

3. The radar system according to claim 1, wherein the first and second radar unit have respective broadside directions approximately 45 degrees from a forward direction of the vehicle.

4. The radar system according to claim 1, wherein the third and fourth radar units are mounted in tail light units of the vehicle.

5. The radar system according to claim 1, wherein the third and fourth radar unit have respective broadside directions approximately 45 degrees from a rearward direction of the vehicle.

6. The radar system according to claim 1, wherein a scanning angle for each of the four radar units is configured to scan between approximately −36 degrees and +36 degrees.

7. The radar system according to claim 1, wherein a scanning angle for each of the four radar units is configured to scan to approximately −36 degrees, −12 degrees, +12 degrees, and +36 degrees.

8. The radar system according to claim 1, wherein each of the four radar units is configured to have a half-power beamwidth between 20 degrees and 25 degrees.

9. The radar system according to claim 1, wherein each of the four radar units is configured to scan the scanning beamwidth in an azimuthal plane of the vehicle.

10. A method of operating a vehicle mounted radar system, comprising:
determining a target direction;
determining a sector associated with the target direction from among a plurality of sectors;
enabling a radar unit associated with the determined sector; and
directing a radar beam in a beam direction nearest to the target direction.

11. The method of claim 10, wherein each radar unit is configured to direct a half-power beamwidth of the radar beam across a 90 degree range of the determined sector.

12. The method of claim 11, wherein a scanning angle for each radar unit is configured to scan to approximately −36 degrees, −12 degrees, +12 degrees, and +36 degrees.

13. The method of claim 11, wherein each radar unit is configured to have a half-power beamwidth between 20 degrees and 25 degrees.

14. The method of claim 10, wherein the plurality of sectors is four sectors.

15. The method of claim 13, wherein each sector comprises a non-overlapping 90-degree section of an azimuthal plane of the vehicle.

16. A computer-readable medium having stored thereon program instructions that when executed by one or more processors cause performance of functions in connection with a computing device, the functions comprising:
determining a target direction;
determining a sector associated with the target direction from among a plurality of sectors;
enabling a radar unit associated with the determined sector; and
directing a radar beam in a beam direction nearest to the target direction.

17. The computer-readable medium of claim 16, wherein each radar unit is configured to direct a half-power beamwidth of the radar beam across a 90 degree range of the determined sector.

18. The computer-readable medium of claim 17, wherein a scanning angle for each radar unit is configured to scan to approximately −36 degrees, −12 degrees, +12 degrees, and +36 degrees and to have a half-power beamwidth between 20 degrees and 25 degrees.

19. The computer-readable medium of claim 16, wherein the plurality of sectors is four sectors.

20. The computer-readable medium of claim 19, wherein each sector comprises a non-overlapping 90-degree section of an azimuthal plane of the vehicle.
